(19) United States
(12) Patent Application Publication
(10) Pub. No.: US 2015/0170084 A1
(43) Pub. Date: Jun. 18, 2015

(54) AUGMENTING BUSINESS PROCESS EXECUTION USING NATURAL LANGUAGE PROCESSING

(71) Applicant: International Business Machines Corporation, Armonk, NY (US)

(72) Inventors: Donna Karen Byron, Boston, MA (US); Sanjay Francis Kottaram, Austin, TX (US); Lakshminarayanan Krishnamurthy, Austin, TX (US); Alexander Pikovsky, Laxington, MA (US)

(73) Assignee: International Business Machines Corporation, Armonk, NY (US)

(21) Appl. No.: 14/104,493

(22) Filed: Dec. 12, 2013

(51) Int. Cl. G06Q 10/06; G06F 17/28

(52) U.S. Cl. CPC G06Q 10/06316; G06F 17/28

(57) ABSTRACT

A system, and computer program product for augmenting business process execution using natural language processing are provided in the illustrative embodiments Information related to a state in a business process is extracted from the business process executing in a data processing system. A set of natural language (NL) questions is formed based on the information and a transition from the state defined in the business process. The set of NL questions is answered with a corresponding set of NL answers, an NL answer in the set of NL answers having an associated confidence rating. A determination is made whether a confidence rating in the set of NL answers exceeds a threshold level of confidence. In response to the confidence rating exceeding the threshold, a task is executed to perform the transition in the business process.

### TECHNICAL FIELD

The present invention relates generally to a method, system, and computer program product for improving business processes. More particularly, the present invention relates to a method, system, and computer program product for augmenting business process execution using natural language processing.

### BACKGROUND

A business process is an organization of steps for completing a task. Typically, a business process includes several steps along one or more flows to complete a targeted task. Furthermore, some steps in a flow can be dependent on other steps.

Some flows are considered normal flows in a business process, while some other flows are considered alternate flows. A normal flow in a business process represents a predicted, desired, or normal course of the process. An alternate flow addresses conditions or exceptions encountered during the execution of the business process. An alternate route allows the business process to complete by satisfying the condition or overcoming the exception in a manner that is preplanned into the alternate flow.

Natural language processing (NLP) is a technique that facilitates exchange of information between humans and data processing systems. For example, one branch of NLP pertains to transforming a given content into a human-usable language or form. For example, NLP can accept a document whose content is in a computer-specific language or form, and produce a document whose corresponding content is in a human-readable form.

### SUMMARY

The illustrative embodiments provide a method, system, and computer program product for augmenting business process execution using natural language processing. An embodiment extracts, from a business process executing in a data processing system, information related to a state in the business process. The embodiment forms a set of natural language (NL) questions based on the information, and a transition from the state defined in the business process. The embodiment answers, using a processor and a memory, the set of NL questions with a corresponding set of NL answers, an NL answer in the set of NL answers having an associated confidence rating. The embodiment determines whether a confidence rating in the set of NL answers exceeds a threshold level of confidence. The embodiment executes, responsive to the confidence rating exceeding the threshold, a task to perform the transition in the business process.

Another embodiment includes a computer usable storage device including computer usable code for augmenting business process execution using natural language processing. The embodiment further includes computer usable code for extracting, from a business process executing in a data processing system, information related to a state in the business process. The embodiment further includes computer usable code for forming a set of natural language (NL) questions based on the information, and a transition from the state defined in the business process. The embodiment further includes computer usable code for answering, using a processor and a memory, the set of NL questions with a corresponding set of NL answers, an NL answer in the set of NL answers having an associated confidence rating. The embodiment further includes computer usable code for determining whether a confidence rating in the set of NL answers exceeds a threshold level of confidence. The embodiment further includes computer usable code for executing, responsive to the confidence rating exceeding the threshold, a task to perform the transition in the business process.

Another embodiment includes a data processing system for augmenting business process execution using natural language processing. The embodiment further includes a storage device including a storage medium, wherein the storage device stores computer usable program code. The embodiment further includes a processor, wherein the processor executes the computer usable program code, and wherein the computer usable program code includes computer usable code for extracting, from a business process executing in a data processing system, information related to a state in the business process. The embodiment further includes computer usable code for forming a set of natural language (NL) questions based on the information, and a transition from the state defined in the business process. The embodiment further includes computer usable code for answering, using a processor and a memory, the set of NL questions with a corresponding set of NL answers, an NL answer in the set of NL answers having an associated confidence rating. The embodiment further includes computer usable code for determining whether a confidence rating in the set of NL answers exceeds a threshold level of confidence. The embodiment further includes computer usable code for executing, responsive to the confidence rating exceeding the threshold, a task to perform the transition in the business process.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of a configuration for augmenting business process execution using natural language processing in accordance with an illustrative embodiment;

FIG. 4 depicts a block diagram of an example application for augmenting business process execution using natural language processing in accordance with an illustrative embodiment; and

FIG. 5 depicts a flowchart of an example process for augmenting business process execution using natural language processing in accordance with an illustrative embodiment.

### DETAILED DESCRIPTION

A business process (process) is generally modeled implemented using a Business Process Modeling (BPM) language, such as Business Process Modeling Notation (BPMN). For example, the normal flows and alternate flows are modeled, using BPMN or a similarly purposed language, to include steps that progress from one node to the next in a set of nodes.

A node where a flow of a process has reached at a given time forms a state of the process at that time. A transaction, operation, process, or sub-process beginning from the node and reaching another node in the process is called a transition. A node in a flow has an associated goal. The goal associated with a node represents the transition that has to be performed to leave the node, advance the process, and reach another node.

Some processes also include exception flows. An exception flow resolves a scenario arising from an exception condition arising during the execution of the process. Exception flows are also modeled in a manner similar to modeling the normal flows and alternate flows, to wit, using a business process modeling language, and including one or more nodes.

The illustrative embodiments recognize that because of the manner of constructing a business process, to wit, by modeling the process using a business process modeling language, the flows and the nodes have to be predetermined and set into the model before the process can execute. In other words, a process designer has to envision the possible states that can be reached in the various flows of the process being designed, and model those states and flows into an executable process. The illustrative embodiments recognize that such pre-determination of process states and flows leads to a rigid process model, which often fails to address conditions arising during the execution of the model.

The illustrative embodiments recognize that to handle such possibilities during the execution, a process model often leads an alternate or exception flow to a node that involves human intervention. The person designated to provide the human intervention typically performs a task (human task) using a user interface or a decision making tool in furtherance of the process.

As an example, during execution, a process modeled using a presently used modeling technique simply parks the currently executing flow to a human role via a special node called human task. The person associated with the human task via a role or group logs into the system and takes the necessary course of action to complete the task. The system then returns the control back to the process for further execution. For example, the task meets the goal of the special node thereby placing the process in a different state, such as in a state in a normal flow, from which the process can resume the execution.

While human intervention is useful in some processes, the illustrative embodiments recognize that processes modeled using presently available techniques make the human intervention time consuming, and imprecise. The illustrative embodiments also recognize that the human task dependents on investigation, data collection, conformity assessment, and other process-relevant tasks, which presently are performed independently and separately from the process execution.

The illustrative embodiments used to describe the invention generally address and solve the above-described problems and other problems related to business process modeling and execution. The illustrative embodiments provide a method, system, and computer program product for augmenting business process execution using natural language processing.

An embodiment improves a process execution by determining, at a human task node, the information or evidence needed to complete the task. The embodiment performs the investigation, data collection, conformity assessment, and other process-relevant tasks to collect such evidence. The evidence includes documents processed or about to be processed in using the business process, results obtained during the execution, collections of business data used by the process, questions in the subject matter domain of the executing process, knowledge or information necessary to answer those questions, and also answers to some or all of those questions.

One embodiment auto-executes the process or a node without human intervention if a confidence level in the evidence exceeds a threshold level of confidence. Another embodiment provides the evidence to the designated human thereby expediting the human intervention and the subsequent return of the process to execution.

Another embodiment improves a process by computing an alternate flow in the process that might presently require explicit process modeling as a separate process or a sub-process. Another embodiment improves the execution of the process by making better or more information available at some or all subsequent nodes of the process through gathering the evidence relevant to those nodes and providing confidence rating to such evidence.

The illustrative embodiments are described with respect to certain methodologies, models, nodes, types of evidence, tasks, operations, data processing systems, environments, components, and applications only as examples. Any specific manifestations of such artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

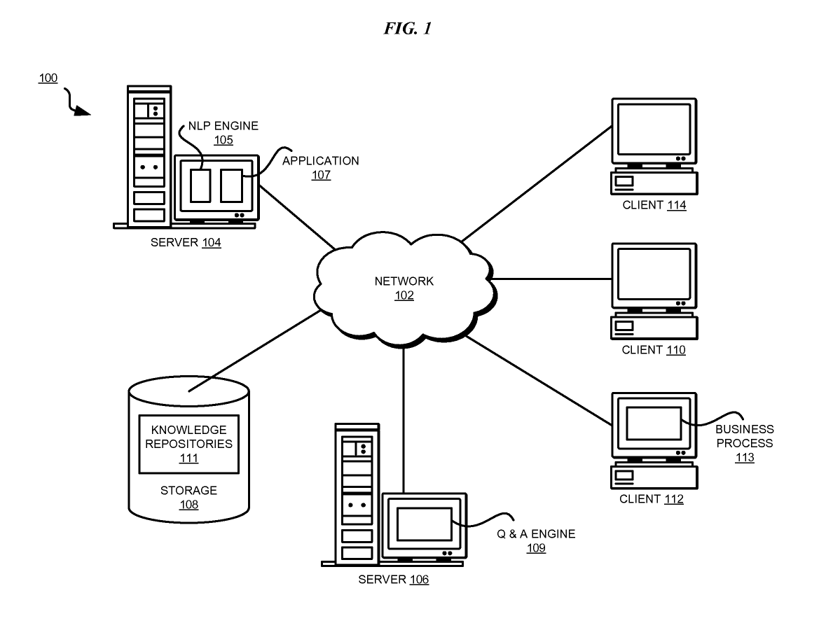

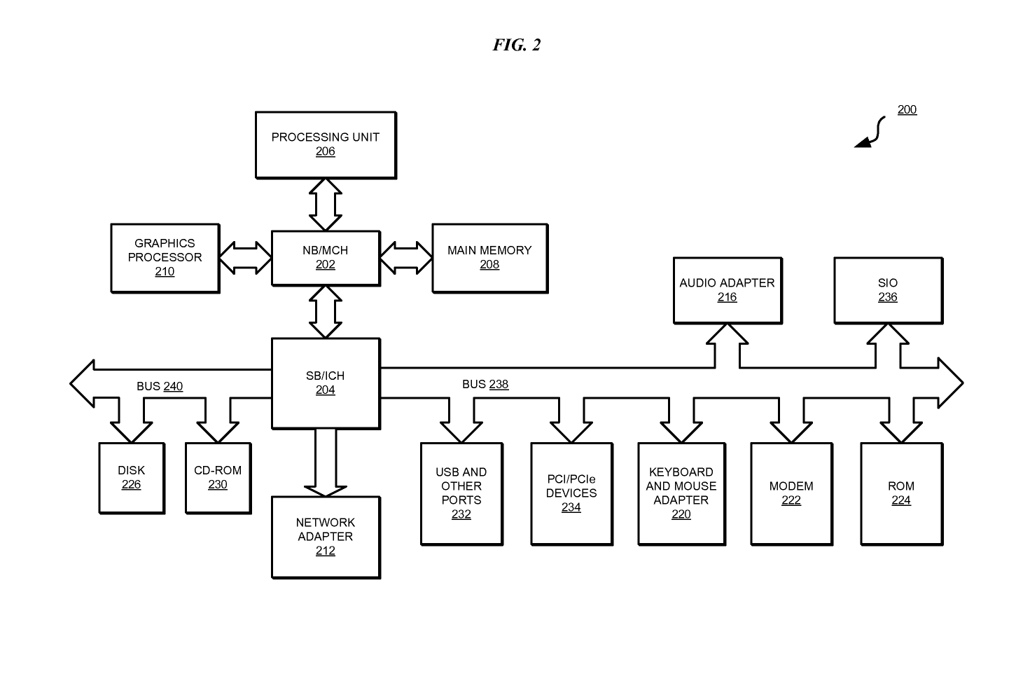

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an embodiment. Natural language processing (NLP) engine 105 is an existing tool or application capable of generating natural language (NL) text from discrete pieces of computer-generated data or computer-selected information, Application 107 implements an embodiment described herein. Question and Answer (Q and A) engine 109 is an existing application that is capable of replying with natural language answers when presented with natural language questions and one or more suitable knowledge base pertaining to the subject matter domain of the question. IBM Watson is an example of Q and A engine 109. (IBM and Watson are trademarks of International Business Machines Corporation in the United States and in other countries).

Q and A engine 109 can be configured to receive inputs from various sources. For example, Q and A engine 109 may receive as input over network 102, a corpus of electronic documents or other data, data from a content creator, information from one or more content users, and other such inputs from other possible sources of input. In one embodiment, some or all of the inputs to Q and A engine 109 may be routed through network 102. The various computing devices on network 102 may include access points for content creators and content users. Some of these computing devices may include devices for storing the corpus of data. Network 102 may include local network connections and remote connections in various embodiments, such that Q and A engine 109 may operate in environments of any size, including local and global, e.g., the Internet. Additionally, Q and A engine 109 can be configured to serve as a front-end system that can make available a variety of knowledge extracted from or represented in documents, network-accessible sources and/or structured data sources. In this manner, some processes populate Q and A engine 109 with input interfaces to receive knowledge requests and respond accordingly.

In one embodiment, a content creator creates content in a document for use as part of a corpus of data with Q and A engine 109. The document may include any file, text, article, or source of data for use in Q and A engine 109. Content users input questions to Q and A engine 109 that Q and A engine 109 answers using the content in the corpus of data. When a process evaluates a given section of a document for semantic content, the process can use a variety of conventions to query such document from Q and A engine 109. One convention is to send the query to Q and A engine 109 as a well-formed question. Semantic content is content based on the relation between signifiers, such as words, phrases, signs, and symbols, and what they stand for, their denotation, or connotation. In other words, semantic content is content that interprets an expression, such as by using Natural Language Processing. In one embodiment, the process sends well-formed questions (e.g., natural language questions) to Q and A engine 109. Q and A engine 109 interprets the question and provides a response to the content user containing one or more answers to the question. In some embodiments, Q and A engine 109 provides a response to users in a ranked list of answers.

In some embodiments, Q and A engine 109 may be the IBM Watson™ Q and A system, which is augmented with the mechanisms of the illustrative embodiments described hereafter. IBM Watson™ Q and A system receives an input question, parses the question to extract the major features of the question, uses the extracted features to formulate queries, and applies those queries to the corpus of data. Based on the application of the queries to the corpus of data, the Q and A system generates a set of hypotheses or candidate answers to the input question, by looking across the corpus of data for portions of the corpus of data that have some potential for containing a valuable response to the input question.

IBM Watson™ Q and A system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ Q and A system. The statistical model may then be used to summarize a level of confidence that the IBM Watson™ Q and A system has regarding the evidence that the potential response, i.e. candidate answer, is inferred by the question. This process may be repeated for each of the candidate answers until the IBM Watson™ Q and A system identifies candidate answers that surface as being significantly stronger than others and thus, generates a final answer, or ranked set of answers, for the input question. More information about the IBM Watson™ Q and A system may be obtained, for example, from the IBM Corporation website, IBM Redbooks, and the like. For example, information about the IBM Watson™ Q and A system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

Knowledge repository 111 represents the corpus of data described above, and comprises is a collection of knowledge bases existing within data processing environment 100 and references to knowledge bases available outside data processing environment 100. A knowledge base (knowledgebase) is any source of information relevant to a given subject matter domain. Ontology is an example of a knowledge base. Generally, a corpus of information organized in any suitable manner, including but not limited to relational databases, flat files, index files, and the like, is usable as a knowledge base within the scope of the illustrative embodiments. Business process 113 is any business process modeled using presently used methodology. Application 107 operates on business process 113 and uses NLP engine 105 and Q and A engine 109 to provide an operation or feature described herein with respect to an embodiment.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, or another type of device in which computer usable program code or instructions implementing the processes may be located for the illustrative embodiments.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as NLP engine 105, application 107, Q and A engine 109, and business process 113 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

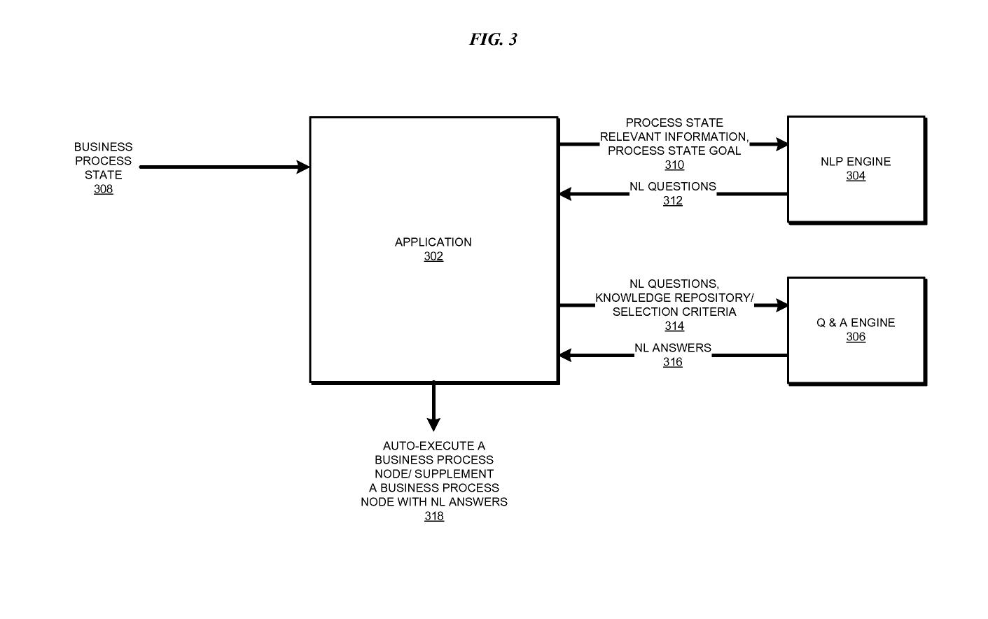

With reference to FIG. 3, this figure depicts a block diagram of a configuration for augmenting business process execution using natural language processing in accordance with an illustrative embodiment. Application 302 can be implemented as application 107 in FIG. 1. NLP engine 304 is an example of NLP engine 105 in FIG. 1. Q and A engine 306 is an example of Q and A engine 109 in FIG. 1.

Application 302 receives information 308 from a business process in execution (in-flight business process). Information 308 includes the present state information including process execution history up to the state, goals of the state, operations, or conditions existing at the state.

For example, in one example embodiment, information 308 pertains to a human task state in which the process is awaiting human intervention at the time of receiving information 308. Information 308 for the human task state includes data used and produced by the process in execution up to the state. Information 308 further includes information about any state-specific conditions, process-wide conditions, or other conditions affecting the human task state.

In such an embodiment, information 308 further includes information about one or more goal of the human task state, any of which can advance the process execution. For example, a goal of the human task state, to wit, a transition that progresses the process execution to another state, may be to verify and send some data to a destination. Upon verification and sending of the data to the destination, the goal of the human task state is achieved (transition performed), and the process lands in a different state.

Application 302 extracts state-relevant information 310 from information 308. For example, in one embodiment, information 310 includes the description of the state and a goal of the state.

Application 302 provides information 30 to NLP engine 304. NL engine 304 transforms information 310 into one or more question 312 in a natural language in a human-readable form, for example, as a grammatically correct English sentence. NLP engine 304 returns one or more NL question 312 to application 302.

Application 302 presents information 314 to Q and A engine 306. Information 314 includes one or more NL question 312 and a combination of one or more subject-matter information repositories (knowledge bases) or references thereto. Q and A engine 306 uses the supplied or referenced knowledge bases to answer NL question 312.

In one embodiment, instead of providing the knowledge bases or references to knowledge bases, application 302 provides Q and A engine one or more criteria or rules for selecting a knowledge base. Q and A engine 306 then selects suitable knowledge bases that match the selection criteria, and used the selected knowledge bases for answering NL question 312.

Q and A engine 306 returns one or more NL answer 316 to application 302. An NL answer 316 corresponds to an NL question 312 in information 314. NL answer 316 is in a natural language in a human-readable form, for example, in one or more grammatically correct English sentence.

Q and A engine 306 can return additional information (not shown) with NL answers 314. For example, in one embodiment, Q and A engine 306 returns a confidence rating with NL answer 316. The confidence rating is a probability of a combination of the correctness, completeness, accuracy, and relevance of NL answer 316 as relates to NL question 312 in information 314.

For example, an answer is more right than wrong by a certain degree of correctness depending on the information on which the answer is based. Depending upon the degree of correctness, the Q and A system computes a probabilistic confidence in the answer, for example, the more correct the answer, the higher the confidence in the answer, and vice versa.

As another example, an answer can be complete to the extent of the information available for preparing that answer. In some cases, the Q and A system is able to identify a gap in the answer that prevents the answer from being complete. The Q and A system then computes the probabilistic confidence (the more complete the answer, the higher the confidence, and vice versa) in the answer based on the completeness of the answer. Optionally, the Q and A system can also provide information about the gap such that another entity, e.g., a system or a user, can obtain the information to fill that gap.

As another example, accuracy is a measure of the closeness of a value of something to the actual value of the thing. An answer has a degree of accuracy depending on how close that answer comes to the actual answer, which is established in some other way. Again, as with correctness, a Q and A system factors in the accuracy of an answer in a probabilistic confidence computation using a degree of accuracy of the answer.

Relevance of an answer indicates how much of the question a given answer answers. For example, an answer that is technically correct but does not answer the question at all may be irrelevant to the question, or at least less relevant than another answer which does answer the question given the available information. As with correctness and accuracy, relevance has degrees, and the more the answer answers the question, the more relevant the answer is to the question, and vice versa.

Application 302 performs action 318 using NL answers 316 and any additional information returned therewith. In one embodiment, action 318 causes application 302 to auto-execute a node, such as a human task node, to progress the business process to another node. In another embodiment, action 318 causes application 302 to supplement a business process node with information usable in performing a task associated with the node.

For example, if the node were a human task node, NL answer 316 would provide the designated human ready answers to the questions the human would have asked, to wit, NL questions 312, in course of performing the human tasks related to a goal of the node. Application 302 can also provide additional information in action 318 besides NL answers 316. For example, in one embodiment, application 302 also provides the confidence levels associated with NL answers 316 to help the human actor in deciding whether to rely on the answers.

The operation of the configuration depicted in FIG. 3 is now described with respect to some example use cases. In one example use case, assume that a business process for processing purchase orders is executing in a data processing system. Assume that a node in the process is a human task node named “credit approval.” In other words, the purchase order process requires a credit approval from a human.

Further assume that a goal of credit approval node is to send the credit application to a third-party for approval. In other words, by a human sending the credit application information to the third-party the purchase order business process progresses from the “credit approval” human task node to another node in the process.

In such an example scenario, application 302 receives information 308, which in part includes the information necessary to complete a credit application from a prospective buyer. Information 308 may also include other information such as the buyer's internal account number, order manifest, and other information processed by the purchase order business process up to the “credit approval” node.

Application 302 extracts state-relevant information 310 from information 308. For example, application 302 extracts the information that the credit application, once prepared, has to be sent somewhere for approval. Other state-relevant information may be a geographical region of the buyer, a type of the buyer, and an amount of the proposed purchase transaction, all of which are relevant to the “credit approval” node, and therefore can be a part of information 310.

An embodiment performs the extraction of state-relevant information by examining state dependencies or transitions. For example, the embodiment determines the information needed to transition from one state to another. Such information forms the state-relevant information. Knowing the state-relevant information, one embodiment can formulate a question to obtain that state-relevant information from another entity. Another embodiment searches for that state-relevant information in a collection, such as in information 308. Another embodiment computes that state-relevant information from information and inferences available in a collection, such as in information 308.

NLP engine 304 could return as NL questions 312, “how would I send a credit application for approval?”, or “how would I send a credit application for this amount of transaction for approval?”, or “how would I get this credit application for this buyer to a third-party credit approver?”, or a combination of these or other similarly structured questions. Notice that each of these questions is structured in a natural language, is understandable by a human, and can be answered by a human in natural language.

Application 302 passes these questions to Q and A engine 306. Application 302 also determines that a list of credit approvers used by the seller is useful information (knowledge base), an ontology of financial transactions is another useful knowledge base, and a specification of reaching outside data processing system from within the data processing environment where application 302 is also a useful knowledge base for answering the questions. Application 302 also sends these knowledge bases, references thereto, or method for selecting them, to Q and A engine 306.

Q and A engine 306, responds with one or more answers 316, which include, “send the credit application to approver xyz via protocol A1 to address https://askdjakjsqkn.apx.” Furthermore, Q and A engine 306 assigns a confidence rating of 0.9 to this answer. Evidence in support of the confidence rating can be portions of the credit approver specifications in the credit approver list, remote system access specifications, and other pieces of information from the knowledge bases used in arriving at the answer. Another answer in NL answers 316 may be “this credit application can be approved using approver abc, pqr, or xyz” with a confidence rating of 0.6 with suitable evidence in support thereof.

Assuming that a confidence threshold is set at 0.8. in one example embodiment, application 302 selects the first answer, finds that the confidence rating of 0.9 exceeds the threshold, and proceeds to auto-complete the action by sending the credit application to approver abc via protocol A1 to address https://askdjakjsqkn.apx. In another example embodiment, application 302 finds that at least one answer fails to exceed the confidence threshold and determines to supplement the “credit approval” node with the answers along with facts extracted from the knowledge base that support the answers. For example, application 302 provides the human user responsible for sending the credit application for approval with the answer, “this credit application can be approved using approver abc, pqr, or xyz” (confidence rating of 0.6).

Such information, when made available to the human user according to an embodiment, makes the human intervention task much more efficient as compared to when the human only knows that a credit application is awaiting approval. Note that choosing one of several answers is only a simplified example for the illustration of the operation of an embodiment and is not intended to be limiting on the illustrative embodiments. Application 302 can select one or more answers from NL answers 316, combine the confidence ratings of the various selected answers, or use another suitable manner of basing action 318 on the answers within the scope of the illustrative embodiments.

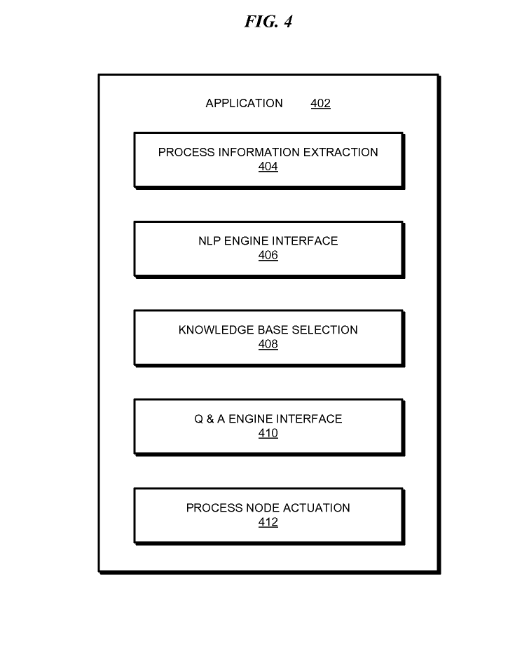

With reference to FIG. 4, this figure depicts a block diagram of an example application for augmenting business process execution using natural language processing in accordance with an illustrative embodiment. Application 402 is an example of application 302 in FIG. 3.

Component 404 of application 402 extracts process information, such as information 310 from information 306 in FIG. 3. Component 406 interfaces with an NLP engine to pass the information extracted by component 404. For example, component 406 interfaces with NLP engine 304 in FIG. 3 to pass information in FIG. 3. Application 402 receives the NL questions and any additional information produced by the NLP engine via component 406 as well.

Component 408 selects one or more knowledge base, reference to a knowledge base, or a combination thereof, to provide to a Q and A engine. In one embodiment, component 408 specifies a selection criterion or configures a selection rule for selecting a suitable knowledge base instead of, or in addition to, selecting the knowledge base or a reference to a knowledge base.

Application 402 provides the knowledge base, the reference to the knowledge base, a selection criterion or rule for selecting a knowledge base, or a combination thereof, to a Q and A engine, such as to Q and A engine 306 as a part of information 314 in FIG. 3. Component 410 provides an interface to the Q and A engine that receives the product(s) of component 408. Application 402 receives the NL answers and additional information produced by the Q and A engine via component 410 as well.

Component 412 performs an action based on NL answers and additional information received at component 410 from the Q and A engine. For example, component 412 performs action 318 in FIG. 3. In one embodiment, application 402 uses component 412 to auto-execute a process node, such as a human task node, and progress the business process to another node. In another embodiment, application 402 uses component 412 to supplement a business process node with information usable in performing a task associated with the node, such as by providing the NL answers and additional information received from the Q and A engine to a designated human to expedite the human's completion of an operation at a human task node in the process.

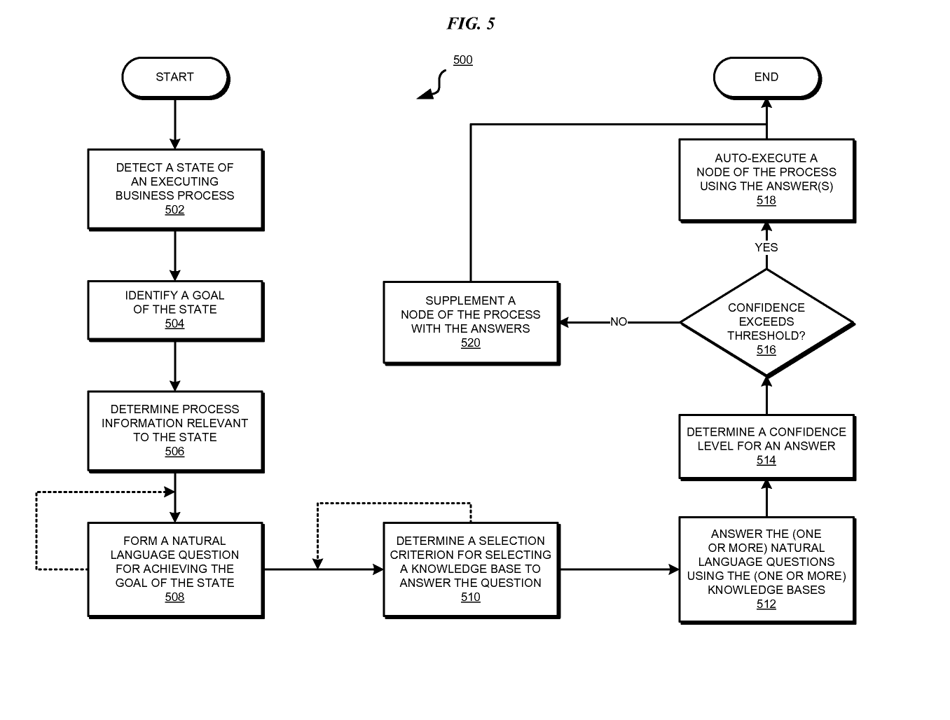

With reference to FIG. 5, this figure depicts a flowchart of an example process for augmenting business process execution using natural language processing in accordance with an illustrative embodiment. Process 500 can be implemented in application 402 in FIG. 4.

The application begins process 500 by detecting a state of an executing business process (block 502). The application identifies a goal of that state, such as from information 308 in FIG. 3 (block 504). The application determines the process information relevant to that state, such as information 310 in FIG. 3 (block 506).

The application forms a natural language question that has to be answered for achieving the goal of the state (block 508). For example, the application uses an NLP engine in the manner described with respect to FIGS. 3 and 4 to perform the operation of block 508. The application may repeat block 508 for forming more than one NL questions in this manner.

The application determines a selection criterion for selecting a knowledge base to answer an NL question formed in block 508 (block 510). In one embodiment, the application selects a knowledge base according to the selection criterion in block 510. The application may repeat block 510 for determining more than one selection criteria, for selecting more than one knowledge bases, or a combination thereof, in this manner.

The application generates one or more NL answers to the one or more NL question using the one or more knowledge bases (block 512). For example, the application uses a Q and A engine in the manner described with respect to FIGS. 3 and 4 to perform the operation of block 512.

The application determines a confidence level of an NL answer generated in block 514 (block 514). For example, the application uses a Q and A engine in the manner described with respect to FIGS. 3 and 4 to perform the operation of block 514.

The application determines whether the confidence level exceeds a threshold level of confidence (block 516). If the confidence level exceeds the threshold (“Yes” path of block 516), the application auto-executes a node of the business process using the one or more NL answers (block 518). The application ends process 500 thereafter.

If the confidence level does not exceed the threshold (“No” path of block 516), the application supplements a node of the business process with the one or more NL answers along with facts extracted from the knowledge base that support the answers (block 520). The application ends process 500 thereafter.

The confidence level threshold of block 516 can be workflow dependent. For example, when the workflow involves a sensitive, critical, or hazardous operation, such as a banking transaction, surgical operation, or nuclear power regulation, setting the confidence threshold to a value that approaches one hundred percent, e.g., a threshold of ninety-five percent, may be desirable. On the other hand, if the workflow involves self-healing operations, e.g., operating a fault-tolerant system, setting the confidence threshold to a lower value, e.g., a threshold of seventy-five percent, may be desirable.

An embodiment further includes a feedback mechanism for providing feedback to the Q and A system as a part of machine learning or machine training process. For example, once the Q and A system has chosen a business process step based on the evidence, the correctness of that choice can be determined by further facts, such as whether the choice resulted in the expected result, whether another entity accepted or rejected that choice, whether that choice was modified by another entity, or a combination thereof.

The feedback mechanism strengthens the Q and A system for future use. For example, a correct choice in the past becomes an additional factor to improve the confidence rating of a similar choice under similar circumstances in the future. For example, in one case, the correctness of a choice is established when an entire task, of which the choice is a part, completes successfully, regardless of a degree of contribution of the choice in the end result.

In another case, the correctness of the choice depends upon the success of that part of the task or sub-task to which the choice makes greater than a threshold degree of contribution. Conversely, a choice that turned out to be incorrect in the past can be used to reduce the confidence level of a similar choice under similar circumstances in the future. The incorrectness of the choice can also be determined based on the success or failure of the overall task or a sub-task in a similar manner. To cause such results in future operations of the Q and A system, the feedback mechanism can create additional data in a knowledgebase, adjust existing data in the knowledgebase, or a combination thereof.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combination of blocks in the block diagrams and/or flowchart illustration, can be implemented by special purpose hardware-based systems that perform the specified functions or acts, or combination of special purpose hardware and computer instructions.

Thus, a computer implemented method, system, and computer program product are provided in the illustrative embodiments for augmenting business process execution using natural language processing. An embodiment acts as an intermediary between the delegating business process and the human task node. An embodiment performs deep analysis using internal or external knowledge bases such as an ontology, corporate database, documentation, business flow models, and other sources of subject-domain specific information.

One embodiment augments the business process by injecting a new process flow, for example, a new flow for automated preparation and transmission of a credit application to a third-party approver from within the corporate data processing environment. Another embodiment also performs deep analysis of the current process and gather or create potential candidate alternate flows or exception flows to provide a thorough analysis to the human actor to improve the human decision-making on the disposition of the task.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable storage medium. A computer readable storage device may be, for example, but not limited to, an electronic, magnetic, optical, electromagnetic, or semiconductor system, apparatus, or device, or any suitable combination of the foregoing. More specific examples (a non-exhaustive list) of the computer readable storage device would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can store a program for use by or in connection with an instruction execution system, apparatus, or device. The term “computer readable storage device,” or variations thereof, does not encompass a signal propagation media such as a copper cable, optical fiber or wireless transmission media.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combination of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

1-12. (canceled)

13. A computer usable program product comprising a computer usable storage device including computer usable code for augmenting business process execution using natural language processing, the computer usable code comprising:
computer usable code for extracting, from a business process executing in a data processing system, information related to a state in the business process;
computer usable code for forming a set of natural language (NL) questions based on the information, and a transition from the state defined in the business process;
computer usable code for answering, using a processor and a memory, the set of NL questions with a corresponding set of NL answers, an NL answer in the set of NL answers having an associated confidence rating;
computer usable code for determining whether a confidence rating in the set of NL answers exceeds a threshold level of confidence; and
computer usable code for executing, responsive to the confidence rating exceeding the threshold, a task to perform the transition in the business process.

14. The computer usable program product of claim 13, further comprising:
computer usable code for creating, responsive to the confidence rating exceeding the threshold, a sub-process in the business process, wherein the sub-process is omitted in a model of the business process, and wherein the sub-process comprises auto-executing the task to perform the transition and omits a human action required in the business process to perform the transition.

15. The computer usable program product of claim 13, wherein the computer usable code for executing omits a human action required for the transition.

16. The computer usable program product of claim 13, wherein the determining further comprises:
computer usable code for determining whether a cumulative confidence in the set of NL answers exceeds the threshold.

17. The computer usable program product of claim 13, further comprising:
computer usable code for sending the set of NL questions to a question and answer (Q and A) engine;
computer usable code for sending a source of domain information to the Q and A engine to use in answering an NL question in the set of NL questions; and
computer usable code for receiving, from the Q and A engine, the set of NL answers with the associated confidence ratings.

18. The computer usable program product of claim 13, wherein the computer usable code is stored in a computer readable storage medium in a data processing system, and wherein the computer usable code is transferred over a network from a remote data processing system.

19. The computer usable program product of claim 13, wherein the computer usable code is stored in a computer readable storage medium in a server data processing system, and wherein the computer usable code is downloaded over a network to a remote data processing system for use in a computer readable storage medium associated with the remote data processing system.

20. A data processing system for augmenting business process execution using natural language processing, the data processing system comprising:
a storage device including a storage medium, wherein the storage device stores computer usable program code; and
a processor, wherein the processor executes the computer usable program code, and wherein the computer usable program code comprises:
computer usable code for extracting, from a business process executing in a data processing system, information related to a state in the business process;
computer usable code for forming a set of natural language (NL) questions based on the information, and a transition from the state defined in the business process;
computer usable code for answering, using a processor and a memory, the set of NL questions with a corresponding set of NL answers, an NL answer in the set of NL answers having an associated confidence rating;
computer usable code for determining whether a confidence rating in the set of NL answers exceeds a threshold level of confidence; and
computer usable code for executing, responsive to the confidence rating exceeding the threshold, a task to perform the transition in the business process.
